(19) United States
(12) Patent Application Publication
(10) Pub. No.: US 2021/0303363 A1
(43) Pub. Date: Sep. 30, 2021

(54) Method for Distributing Sub-applications of a Certain Application Among Computers of Platforms of at Least Two Different Levels

(71) Applicant: Siemens Aktiengesellschaft, Muenchen (DE)

(72) Inventors: Fei LI, Wien (AT); Sebastian MEIXNER, Wien (AT); Daniel SCHALL, Hollabrunn (AT)

(21) Appl. No.: 17/257,812

(22) PCT Filed: Jun. 25, 2019
(86) PCT No.: PCT/EP2019/066788

§ 371 Date: Jan. 4, 2021

(30) Foreign Application Priority Data
Jul. 5, 2018 (EP) 18181819

(51) Int. Cl. G06F 9/50; G06F 16/901

(52) U.S. Cl. CPC G06F 9/5066; G06F 9/5077; G06F 2209/506; G06F 16/9024; G06F 9/5083

(57) ABSTRACT

A method for distributing sub-applications among computers of at least two different levels, wherein a first level has more computing power available than a second level, where constraints for execution of an application and individual sub-applications are registered in a database, where prerequisites of the different levels that correspond to the constraints for execution, namely prerequisites of the at least one platform of a level, are registered in a database, where the sub-applications necessary for the application are selected, where, from the constraints for the application and individual sub-applications and from the corresponding prerequisites of the different levels, namely the at least one platform of each level, a constraint satisfaction problem is automatically created and solved, and where the sub-applications are distributed among computers of the different platforms in accordance with the solution of the constraint satisfaction problem such that the method becomes plannable in an automated and traceable manner.

### CROSS-REFERENCE TO RELATED APPLICATIONS

This is a U.S. national stage of application No. PCT/EP2019/066788 filed 25 Jun. 2019. Priority is claimed on European Application No. 18181819.6 filed 5 Jul. 2018, the content of which is incorporated herein by reference in its entirety.

### BACKGROUND OF THE INVENTION

### 1. Field of the Invention

The present invention relates to a method, using a computer, for deploying sub-applications of a particular application on computers of at least two different levels, where a first level has more computational power available than a second level.

The method may generally be applied wherever a particular software application can be divided into a plurality of sub-applications and these sub-applications are executed by different computers, such as in the field of industrial automation or in the case of applications for what is known as the Internet of Things.

### 2. Description of the Related Art

In principle, there are two different levels on which software may be executed. One level is what is known as a cloud, also called computer cloud or data cloud. The cloud level may consist of a plurality of different cloud platforms, which are normally offered by various providers. A cloud platform makes available IT infrastructure, such as memory space, computational power or application software, as a service via the Internet. Cloud platforms have available virtually unlimited resources, as a result of which it is possible, as desired, to scale, in particular expand, services that are executed on a cloud platform. Disadvantages of the cloud level are lack of confidentiality and lack of real-time services. The lack of confidentiality is due to the fact that the user is usually not the owner of the cloud platform and thus does not have any control over their data located in the cloud. Real-time services are barely possible because data must be transmitted multiple times from the user to the cloud level and back from there via the Internet, which leads in each case to delays caused by the transmission time.

The second level on which software may be executed is referred to as edge. Edge computing, in contrast to cloud computing, denotes decentralized data processing, in particular at the edge of a computer network. Computer applications, data and services are delegated from central nodes (computer centers) away to the outer edges of a network. In this case, it is also possible for the edge level to consist of a plurality of platforms. The edge network is usually (legally and spatially) owned by the user. This ensures confidentiality and the possibility of real-time services, for the latter in particular when the individual units of the edge are in close spatial proximity to one another and are connected to one another by fast network connections. One disadvantage is that the resources of the edge are limited and cannot be expanded as desired.

Each level may be formed by one or more platforms. Each of these platforms may in turn satisfy different functional and non-functional requirements.

If it is desired to combine the advantages of the two levels, then it is necessary to divide applications appropriately into sub-applications, what are known as micro-services, which then run on one of the two levels. Micro-services are an information technology architecture pattern in which complex application software is formed from independent sub-applications that communicate with one another via language-independent programming interfaces. The sub-applications are largely decoupled and each perform a small task. The decision as to which sub-application should be executed on which level and furthermore on which specific platform is complex, susceptible to errors and should, in the best-case scenario, be performed in an automated manner. Decision criteria do not provide the non-functional requirements (NFR) of the respective sub-application, which contain, for example, the scalability of the application and its required confidentiality.

After it has been decided whether the sub-application should be executed in the cloud or in the edge, it is possible to decide the specific cloud or edge platform on which the sub-application should be executed, based on the requirements of the sub-application on its target platform. It may then be decided on which unit (which host) precisely on this platform this should take place, for instance on which physical unit of an edge platform. The host must contain appropriate resources (software, tools, libraries) in the required version so that the sub-application can be executed correctly. Communication must furthermore be possible between two different platforms when different mutually dependent sub-applications are deployed on each one of the platforms.

The decision about which sub-application should be executed on which level has up until now been made either with support from the user, as is the case in what is known as the Disnix system. Mohamed El Amine Matogui and Sebastien Leriche, in the publication “A middleware architecture for autonomic software deployment”, propose for the user to set boundary constraints for the sub-applications, which are then converted into a constraint satisfaction problem (CSP), without however particular dependencies between required software being taken into consideration. Any required software is therefore then downloaded onto a unit, which is often undesirable if not enough memory space is present.

Many approaches for connecting cloud and edge to one another are found under the phrase fog computing, see for instance “A Survey of Fog Computing: Concepts, Applications and Issues” by Shanhe Yi, Cheng Li and Qun Li, or “Fog Computing: A Platform for Internet of Things and Analytics” by Flavio Bonomi, Rodolfo Milito, Preethi Natarajan and Jiang Zhu, N. Bessis and C. Dobre. These include approaches where developers define which parts of the functionality of a sub-application may be delegated into the cloud if a unit of the edge is overloaded. Alternatively, there are approaches where the processes always have to be assigned to a particular level based on non-functional requirements, such as confidentiality.

Amazon Greengrass allows developers to execute applications transparently either in the cloud or on Greengrass IoT units that form an edge platform, which may be performed upon certain events. Google Cloud IoT Core and Microsoft Azure IoT Suite also allow edge and cloud to be linked.

However, none of these previously known systems makes it possible to plan the decisions as to which sub-application should run on which level and on which specific platform in an automated and transparent manner.

### SUMMARY OF THE INVENTION

In view of the foregoing, it is therefore an object of the invention to provide a method via which the decisions as to which sub-application should run on which level are planned in an automated and transparent manner, and such that this plan in particular can also be changed.

This and other objects and advantages are achieved in accordance with the invention by a method, using a computer, for deploying sub-applications of a particular application on computers of at least two different levels, each comprising at least one specific platform, where a first level (correspondingly the platform(s) of the first level) has more computational power available than a second level (correspondingly the platform(s) of the second level). in accordance with the method of the invention, constraints for the execution of the application and also of the individual sub-applications are recorded in a database, in particular a graph database, requirements, corresponding to the constraints for execution, of the different levels, specifically requirements of the at least one platform of a level, are recorded in a database, in particular a graph database, the sub-applications required for the particular application are selected, from the constraints for the application and also for the individual sub-applications and from the relevant requirements of the different levels, specifically of the in each case at least one platform of the levels, a constraint satisfaction problem is created and solved automatically, and the sub-applications are deployed on computers of the different platforms in accordance with the solution to the constraint satisfaction problem.

A platform of the first level may in particular be what is known as a cloud platform (computer cloud) that is connected to the computer that executes the method in accordance with the invention via the Internet. A platform of the second level may be a local computer network that is spatially closer to the computer that executes the method in accordance with the invention. A platform of the second level may thus be a computer network located spatially close (proximate) to the user of the method and that allows a temporally shorter data transport from and to the computer of the user than one, in particular all of the, platforms of the first level.

In the method in accordance with the invention, software developers are allowed to specify non-functional requirements and other boundary constraints for their sub-applications, where the system in accordance with the invention determines an optimized plan for deploying the software (deployment plan), specifically for deploying the sub-applications on one of possibly a plurality of cloud platforms or one of possibly a plurality of edge platforms.

By virtue of a tool in the form of software, the software developer can define the non-functional requirements and other boundary constraints for particular individual sub-applications and can also see which level and possibly which unit (which computer) of this level supports these requirements and boundary constraints. These data are preferably modeled in a graph-oriented database (also known as graph database), where appropriate units (computers) for a particular sub-application can be identified quickly and easily by running through the graph.

A graph database (or graph-oriented database) is a database that uses graphs to represent and store highly networked information. Such a graph consists of nodes and edges, the connections between the nodes. Both nodes and edges may have properties (for example, name, or identification number). Graph databases offer specialized graph algorithms for simplifying complicated database queries. They thus offer, for example, algorithms for running through graphs, i.e., for finding all direct and indirect neighbors of a node, calculating shortest paths between two nodes, finding known graph structures, such as cliques or identifying hotspots of particularly highly networked regions in the graph.

Users can then provide a list of sub-applications that are intended to be executed and for which an optimized deployment plan should be created. Here, optimization relates to targets or target functions that are specified by the user or by the system itself. It is also possible to take into consideration dynamic boundary constraints that are derived from the instantaneous state of the system (for example, availability of memory or computational power).

It is furthermore possible to achieve a compromise between the degree of satisfaction of the non-functional requirements and the costs of the resulting deployment of sub-applications if the costs of resources in the various cloud platforms are incorporated into the target function. By way of example, the failure safety of a sub-application may thus be increased by deploying a plurality of instances, but only if the accumulated costs of the required resources in the cloud remain below a certain threshold value.

In one embodiment of the invention, the costs of resources on the individual platforms are taken into consideration when creating the constraint satisfaction problem. The corresponding method step consists in a constraint satisfaction problem being created and solved automatically from the constraints for the application and also for the individual sub-applications and from the relevant requirements of the different levels, specifically the in each case at least one platform of the levels, and the costs of resources on the individual platforms.

The optimized deployment plan is determined, in accordance with the disclosed embodiments of the invention, using a constraint satisfaction problem (CSP) method. A CSP is a problem where it is necessary to find a state (that is, an allocation of variables) that satisfies all of the set constraints.

A constraint satisfaction problem consists of a set of variables, their ranges of values and the constraints that create links between the variables and thereby define which combinations of values of the variables are permissible. A CSP is solved by finding an allocation of the variables that meets all of the constraints. In contrast to other optimization problems, in which a “best possible” solution is sought, constraint satisfaction problems require each individual constraint to be completely satisfied. Here, there may by all means be multiple solutions.

The solution of the CSP method, i.e., the software deployment plan that is found, may be authorized for execution manually by the user or automatically. The user may read the plan, thereby making this plan transparent to the user.

There may also be provision for a plan that has been determined once to trigger an alarm or to be changed, in particular recalculated and executed, based on measured values, states and/or feedback from executing units and/or on the basis of user specifications (for example, events defined by the user).

In one embodiment of the invention, the constraints for the execution of the sub-applications and/or the requirements of the different levels and/or the specific platforms comprise at least one of the following properties: reliability, availability, scalability, confidentiality, efficiency, safety, usability, prices of different resources, communication with other sub-applications and/or platforms. With regard to communication with other sub-applications and/or platforms, this comprises the requirement to communicate with other sub-applications or the option to communicate with other platforms. Scalability means that, when needed, more resources, instance, i.e., more computational power, more memory or even a plurality of computers, are made available to the application.

In another embodiment of the invention, the constraints for the execution of the sub-applications and/or the requirements of the different levels and/or the specific platforms and/or the individual computers (computer units) comprise at least one of the following properties: presence of at least one particular additionally required item of hardware and/or software, in particular in the correct version.

This means that the requirements of the different levels may comprise requirements of the individual computers of the respective level. In turn, this means it is possible to define not only the properties of a whole level or platform, but rather also (in addition or as an alternative) properties of particular computers or hosts of a level or platform.

In this case, there may in particular be provision that at least one sub-application is deployed on a particular computer of a specific platform of a level, i.e., assigned thereto for execution, in accordance with the solution to the constraint satisfaction problem.

There may be provision for the constraints for the execution of the sub-applications to comprise particular boundary constraints being determined automatically, based on information that is present. By way of example, there may be provision for two sub-applications not to be allowed to be deployed on the same platform or the same computer of a platform.

The constraints for the execution of the sub-applications may generally comprise that particular sub-applications are not allowed to be deployed on the same level, the same platform of a level or the same computer of a platform. This may, for example, be down to safety reasons.

There may also be provision that the constraints for the execution of the sub-applications comprise two different sub-applications being dependent on one another and communication being possible between these platforms when the sub-applications are deployed on different platforms.

There may be provision that, in the event of a change in a requirement of the different levels or platforms, the constraint satisfaction problem is changed and solved again, and the sub-applications are redeployed on computers of the different levels or platforms in accordance with the new solution to the constraint satisfaction problem.

The change in a requirement of the different levels or platforms may be a change in a state (for example, available computational power, memory loss, deactivation of individual units of the level, loss of data connection), or to a rule of a platform or of a computer of a platform. The change in the state or to a rule may comprise the change in the price of one or more resources on at least one of the platforms.

A rule may, for example, stipulate that, when the use of all instances of a sub-application for a certain time is below or above a particular threshold value, then the number of instances that are used should be lowered or raised accordingly. Alternatively, a rule may be that high loading of units in the edge is acceptable as long as the price of computational power in the cloud is above a particular threshold value. A further rule may be that the number of instances of a particular sub-application is increased when the price of computational power in the cloud is below a certain value, as a result of which it is possible to achieve better failure safety.

The change in a requirement of the different platforms may in particular be a change in the loading of a platform or of a computer of a platform.

There may be provision that at least one constraint for the execution of the sub-applications can be specified by a responsible individual, such as the developer.

In a further embodiment of the invention, in the case of events specified by the user, the constraint satisfaction problem is changed and solved again, and the sub-applications are redeployed on computers of the various platforms in accordance with the new solution to the constraint satisfaction problem.

The method in accordance with the disclosed embodiments of the invention is executed on or using a computer. As a result, the disclosed embodiments of the invention also comprise a corresponding computer program product (computer-readable medium) that, in turn, comprises commands of a computer program which, when the computer program is executed by a computer, prompt the computer to execute all of the steps of the method in accordance with disclosed embodiments of the invention. The computer program product or computer-readable medium may, for example, be a data carrier on which a corresponding computer program is stored, or it may be a signal or data stream that can be loaded into the processor of a computer via a data connection.

The computer program may thus prompt the following steps or perform them itself: (i) constraints for the execution of the application and also of the individual sub-applications are recorded in a database, in particular in a graph database (for example, by being input by a user or by reading in data), (ii) requirements, corresponding to the constraints for execution, of the different levels, specifically requirements of the at least one platform of a level, are recorded in a database, in particular a graph database (for example by being input by a user or by reading in data), (iii) the sub-applications required for the particular application are selected (for example, by being input by a user or by reading in data), (iv) from the constraints for the application and also for the individual sub-applications and from the relevant requirements of the different levels, specifically of the in each case at least one platform of the levels, a constraint satisfaction problem is created and solved automatically, and (v) the sub-applications are deployed on computers of the different platforms in accordance with the solution to the constraint satisfaction problem.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In order to further explain the invention, the following part of the description refers to the figures, from which it is possible to derive further advantageous features and possible fields of use of the invention, in which:

FIG. 1 shows a schematic illustration of the information flow in the method in accordance with the invention;

FIG. 2 shows a basic architecture of a computer system for the execution of the method in accordance with the invention;

FIG. 3 shows a graphical illustration of two sub-applications and their execution constraints in accordance with the invention;

FIG. 4 shows a graphical illustration of the application and its sub-applications, together with a possible level for the execution of the sub-applications in accordance with the invention;

FIG. 5 shows a graphical illustration of the edge with its requirements in accordance with the invention;

FIG. 6 shows the solution to the constraint satisfaction problem of FIGS. 4 and 5; and

FIG. 7 shows a result of the execution of the application of FIGS. 4-6.

### DETAILED DESCRIPTION OF THE EXEMPLARY EMBODIMENTS

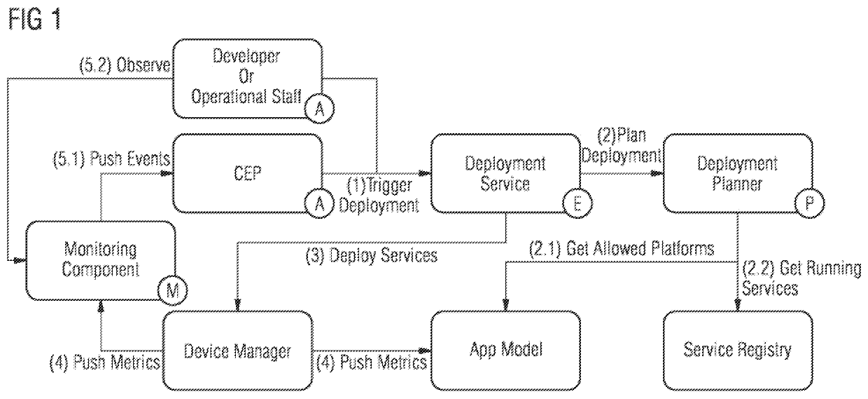

FIG. 1 shows the information flow in a system in accordance with the invention. There are various ways of being able to redeploy the sub-applications: through manual intervention by the user, automatically as part of a continuous integration (CI) pipeline or through complex event processing (CEP). Continuous integration (CI) describes the process of continuously combining sub-applications to form an application. The foregoing occur sequentially. Consequently, reference is made to a pipeline. Complex event processing (CEP) involves recognizing, analyzing, grouping and processing mutually dependent events. The corresponding methods and tools process events as they occur, i.e., continuously and promptly. From events, CEP derives high-level, valuable knowledge in the form of “complex events”, i.e., situations that can be recognized only as a combination of a plurality of events. To process data streams of different types in real time and to extract and analyze the events, systems in this regard have to cope with high loads.

FIG. 1 shows a monitor analyze plan execute (MAPE) cycle. The monitoring (Monitor), letter M in FIG. 1, is performed in the monitoring phase via the “Monitoring Component”, the analysis (Analyze), letter A in FIG. 1, is performed via the Complex Event Processing “CEP” (or alternatively by the developer or operator, “Developer Or Operational Staff”), the planning (Plan), letter P in FIG. 1, is performed by way of the deployment planner (“Deployment Planner”) and the execution (Execute), letter E in FIG. 1, is performed using the deployment service (“Deployment Service”).

Complex event processing allows the operator of the edge (e.g., the performance engineer or the operations manager) to specify particular rules for a particular sub-application, for example, that only two CPUs may experience load peaks during a particular time interval, or that the memory consumption in a particular time interval is not allowed to exceed a particular threshold. The operator may additionally provide callback of the sub-application if these rules are triggered. The callback may, for example, be forwarded to the deployment service (Deployment Service), which triggers a redeployment. Another possibility for callback would be sending a message to an individual who is entrusted with monitoring the system.

If a deployment is triggered, see arrow 1 “Trigger Deployment”, then the deployment service (Deployment Service) calls the deployment planner (Deployment Planner), upon which this collects all of the required information to calculate an optimized deployment plan, see arrow 2 “Plan Deployment”. This comprises the levels or units permitted for the sub-applications to be deployed (Allowed Platforms), see arrow 2.1 “Get Allowed Platforms”, and the applications running at the time, see arrow 2.2 “Get Running Services”. The sub-applications to be deployed are made available by the deployment service (Deployment Service) or by the developer (Developer). For an application that consists of a plurality of sub-applications, all of the sub-applications should in principle be planned and only any sub-applications for which a better unit for execution is found are then deployed or migrated differently. The information required for this may be supplied by the app model and by the service registry. The app model defines how an application can be executed, which data formats it can receive and transmit and which operations on data it needs and makes available. The service registry contains further information regarding the individual sub-applications, typically their memory location, their runtime and constraints for their termination.

The information is required in order to create an optimum deployment plan for the given sub-applications. This deployment plan is returned to the deployment service (Deployment Service), which then takes over the deployment and deploys the sub-applications to the manager of the units (Device Manager), see arrow 3 “Deployment Manager”. After a sub-application has been launched, it registers with the manager of the units (Device Manager), and this starts to collect measured values, such as metrics, of the executing unit, such as CPU loading and available memory space. These measured values are forwarded to the monitoring unit (Monitoring Component), see arrow 4 “Push Metrics”. The manager of the units (Device Manager) may preprocess the measured data and forward them, in transformed form, to the monitoring unit (Monitoring Component). The monitoring unit (Monitoring Component) for its part forwards the data to the complex event processing unit CEP, see arrow 5.1 “Push Events”. The complex event processing unit CEP analyzes the data based on the rules specified by the user and triggers redeployment of the sub-applications if necessary, see arrow 1 “Trigger Deployment”. This deployment may, for example, bring about scaling of the sub-application, this depending on whether and which rules have been defined. A user could, for example, define when the use of all instances of a sub-application for a particular time is below or above a particular threshold value, where the number of instances used should be correspondingly lowered or raised. A user could also define that high loading of units in the edge is acceptable as long as the price of computational power in the cloud is above a particular threshold value. The deployment of the sub-applications may also be triggered by the developer if the developer incorporates corresponding instructions in the control unit for the source code version, which in turn triggers the continuous integration (CI) pipeline. The deployment of the sub-applications may also be launched manually by the user if the user considers this necessary. This manual launching of the deployment is represented by arrow 5.2 “Observe”.

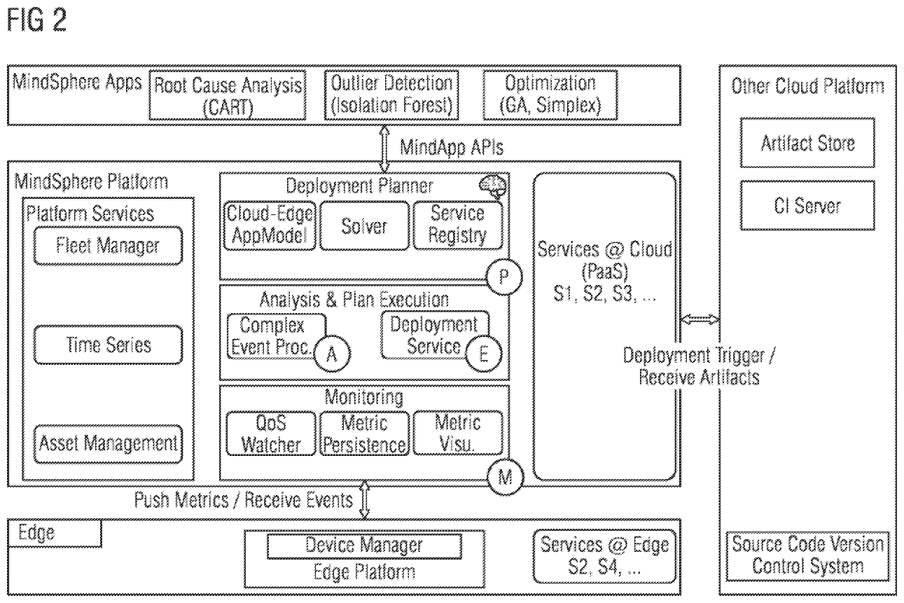

FIG. 2 shows a possible basic architecture of the solution in accordance with the invention. The architecture comprises a cloud-based, open IoT operating system, here having the name “MindSphere Platform” from Siemens. This is connected to the level of the edge in order to exchange measured values and events, this being illustrated by the double-headed arrow “Push Metrics/Receive events”.

The illustration of the basic architecture in FIG. 2 shows only in each case one specific cloud and edge platform for the sake of clarity. The method in accordance with the invention is not however limited to one individual platform per level.

The cloud-based, open IoT operating system “MindSphere Platform” is connected to a further level, “MindSphere Apps”, on which further applications of the IoT operating system run, such as fault root cause analysis (“Root Cause Analysis (CART)”), identification of deviations, for example, via isolation forest methods (“Outlier Detection (Isolation Forest)”) and optimization, for example, using simplex methods or using genetic algorithms (“Optimization (GA, Simplex)”).

The cloud-based, open IoT operating system “MindSphere Platform” comprises, illustrated on the left, general services (“Platform Services”), illustrated in the middle, the tool for the automatic deployment of the sub-applications and, illustrated on the right, the sub-applications “Services@Cloud”, S1, S2, S3, which can be executed in the cloud. The general services (“Platform Services”) comprise, for example, a “Fleet Manager” (that allows the measured values that have been collected for properties of different units to be visualized), “Time Series” (a unit for recording temporally successive measured values) and an “Asset Management” (that allows various properties of a group of units, such as for example motors, to be defined).

The tool for the automatic deployment of the sub-applications has three levels and implements a MAPE cycle. The level of the deployment planner (Deployment Planner) is responsible for calculating an optimum deployment plan for each deployment request. This level comprises the cloud edge application model (Cloud Edge App Model), where developers define their applications together with non-functional requirements (NFR), and where this information is stored in a graph database. A more precise description of the data model and of the applications in this respect follows below. All running sub-applications are registered in the service registry. Additionally provided is a solution service (Solver) that makes available an application programming interface (API), i.e., a program portion that serves other programs for connection to the individual sub-application. A new deployment plan can thereby be created. Here, the user has multiple options for exerting influence:

Initially, the user may name only the sub-applications that they wish to deploy, and otherwise use the predefined models with the predefined target functions. Secondly, the user may specify a dedicated target function that is used to optimize the deployment. Furthermore, the user may even specify a dedicated model for the deployment of the sub-applications.

The second level is called “Analysis & Plan Execution” and comprises planning and execution; it accordingly contains the complex event processing unit CEP and the deployment service (Deployment Service). The second level prepares the data for the planning and executes the deployment as a result of the planning. The deployment service (Deployment Service) serves as input to the system. A developer may trigger a redeployment, here. The deployment service (Deployment Service) then receives the optimized deployment plan from the deployment planner (Deployment Planner) and takes over the actual deployment.

In the third level, the “Monitoring”, three applications are provided here, “QoS Watcher”, which receives the measured values from the units, forwards them to the complex event processing and executes callbacks in accordance with the rules defined by the user. The “Metric Persistence”, which likewise receives measured values from the “QoS Watcher” and stores them in a database. The “Metric Visu” (short for “Metric Visualization”), which allows the measured values stored by the “Metric Persistence” to be loaded and graphically displayed.

Units that host the manager of the units (Device Manager) run in the edge level. This is responsible for monitoring any applications that run on the same host (computer) as itself, and for transmitting measured values to the cloud. The manager of the units (Device Manager) furthermore receives commands from the deployment planner (Deployment Planner) in order to launch or to stop particular sub-applications. The sub-applications “Services@Edge”, S2, S4 may be executed in the edge.

Other cloud applications (Other Cloud Platform), based here on IaaS (Infrastructure as a Service), are illustrated on the right in FIG. 2. They contain, for instance, applications for the deployed version management of files (Source Code Version Control System), such as Git. If developers transmit their changes to applications for deployed version management, a CI server (for example, Jenkins) for continuous integration is triggered in order to find the most recent change and then to construct the application accordingly from the possibly changed sub-applications. If the construction is successful, then the resultant software artifacts are stored in an artifact memory (Artifact Store), such as a JFrog Artifactory. When all of the sub-applications have been successfully combined to form an application, the CI server triggers redeployment of the sub-applications at the deployment service (Deployment Service). These procedures between the other cloud applications and the cloud region “MindSphere Platform” are illustrated in FIG. 2 by the double-headed arrow “Deployment Trigger/Receive Artifacts”.

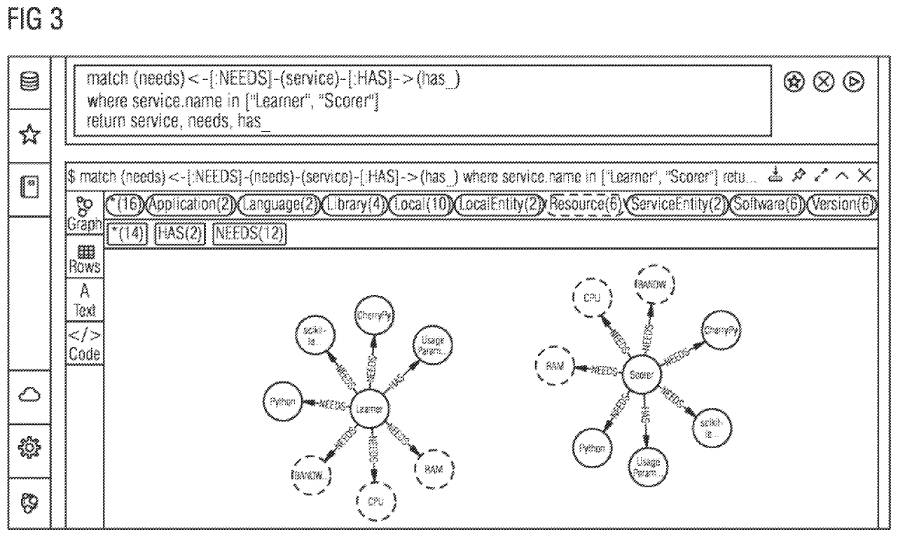

To illustrate the information flow in the method in accordance with the invention, a small application case is now intended to be presented with reference to FIGS. 3-7. An application for detecting outliers was implemented here, the outlier application, specifically by way of two sub-applications, the learner (“Learner”) and the scorer (“Scorer”). The aim is to detect outliers in the sensor measured values, for example, the motor temperature. Both sub-applications are implemented via the Python programming language in the example. Skicit-learn was used as the library for the machine learning, and an isolation forest method was implemented for learning of the model.

The learner collects data, stores them locally and trains a machine learning model to detect outliers. The learner retrains the model at regular intervals in order to take into consideration changing constraints. After the model has been trained, it is stored at a memory location that is accessible to both sub-applications. The learner, depending on the training intervals, possibly has rather a large amount of data to process during training. As a result, the learner will require a large amount of computational power to do this, and the number of models for which data have to be collected may additionally fluctuate over time. Scalability of the sub-application would thus be advantageous. Prompt or even real-time data processing for the model or the data collection is by contrast not necessary.

The scorer, on request, loads available models from the memory location and evaluates them, i.e., the scorer applies a model to a given data record. The scorer then transmits the data record to a time series database (“time series store”, see application “Time Series” in FIG. 2) and marks it there as a possible outlier, depending on the result of the evaluation. The scorer additionally returns the information as to whether an outlier is present to the requesting application. The evaluation does not require a large number of resources, and the models are usually far smaller than the files containing the data records. In this respect, the scorer may be executed on units that have only limited resources available. On the other hand, it is likely that the requesting application requires the information as to whether or not an outlier is present promptly, i.e., the evaluation should occur nearly in real time.

Both sub-applications were implemented and stored in the app model, i.e., their requirements in terms of resources, software and use. This is illustrated in FIG. 3. The learner (“Learner”) requires (“NEEDS”) RAM, CPU, bandwidth “BANDW . . . ” and various software such as Python, and has (“HAS”) various usage parameters (“Usage Param.”). The same applies to the scorer (“Scorer”).

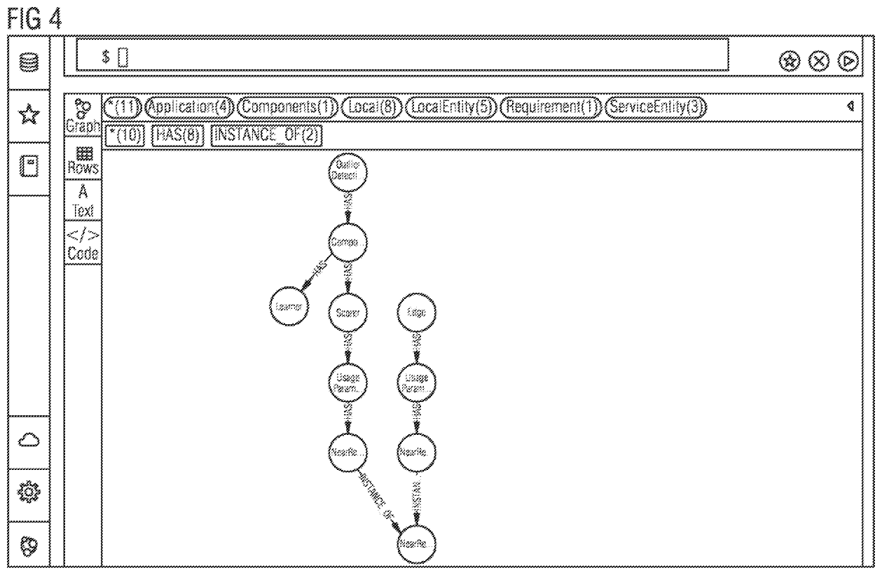

It may be seen in FIG. 4 that the outlier application “Outlier Detector” comprises (“HAS”) two sub-applications “Learner” and “Scorer”, which each have usage parameters (“Usage Param.”). These usage parameters, in this case “NearRealTime” (“NearRea . . . ”), i.e., “near real time”, may be made available by platforms, here by the edge.

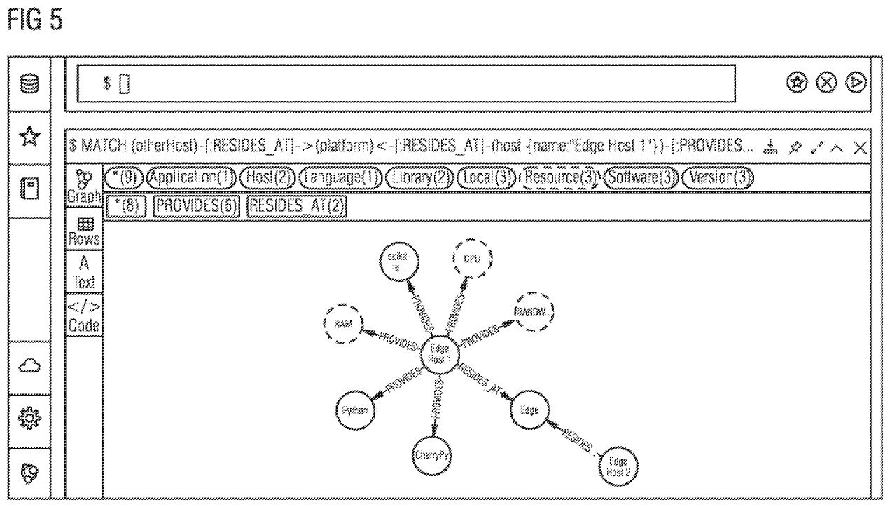

Two platforms (one for each level) have been defined, upon which sub-applications may be deployed or delegated, specifically a private cloud platform and an edge platform. The private cloud platform (“Edge Host 1”) makes available (“PROVIDES”) variable scaling and confidentiality, as well as RAM, CPU, bandwidth “BANDW . . . ” and various software such as Python. This is illustrated in FIG. 5.

The following information flow assumes that work was performed using a MindSphere System and that a device manager is executed on each host (computer) that is not managed directly by a platform. To launch the outlier application and to deploy the sub-applications, it is simply necessary to call the corresponding REST endpoint of the deployment service (Deployment Service) with an assignment of the names of the sub-applications to an integer that corresponds to the desired number of instances. This corresponds to the arrow (1) “Trigger Deployment” in FIG. 1. The deployment service (Deployment Service) then calls the deployment planner (Deployment Planner) with a list of the sub-applications that are intended to be deployed. The deployment planner (Deployment Planner) collects all of the required information to calculate an optimized deployment plan, see arrow 2 “Plan Deployment”. The deployment planner (Deployment Planner) first of all contacts the app model in order to find the permitted units (Allowed Platforms) for the required sub-applications, see arrow 2.1 “Get Allowed Platforms” in FIG. 1.

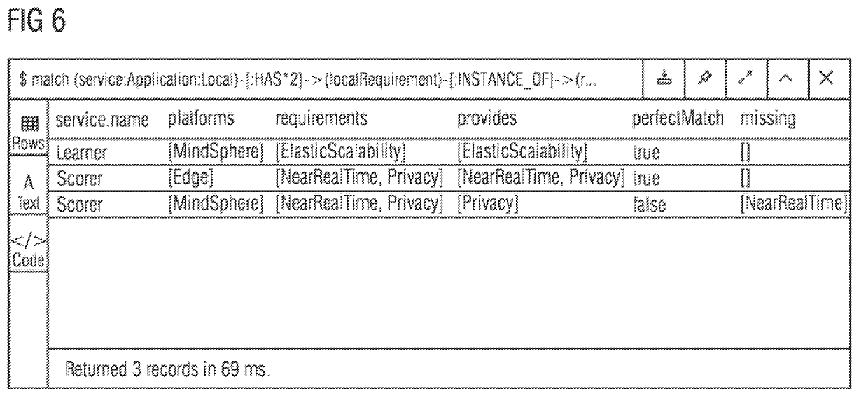

The internal result of the app model in this regard is illustrated in FIG. 6. The names of the sub-applications “service.name” are listed, and also the possible platforms (“platforms”) or levels, i.e., the private cloud (“MindSphere”) and the edge, the required requirements (“requirements”) or available properties (“provides”) such as scalability (“ElasticScalability”), near real-time data processing (“NearRealTime”) and confidentiality (“Privacy”). In the column “perfectMatch”, “true” and “false” illustrate whether there is a match between required requirements and available properties. The last column “missing” specifies which required requirements are not satisfied.

The result is transformed, for example, in JSON, and returned to the deployment planner (Deployment Planner). The result may be a simple assignment that assigns each sub-application to a list of platforms on which it can be deployed. This corresponds to the response in the direction opposite to arrow 2.1 “Get Allowed Platforms” in FIG. 1.

The deployment planner (Deployment Planner) then retrieves the list of the currently running applications, see arrow 2.2 “Get Running Services”, uses the data to create a file and the dynamic part of the CSP method, which is defined here via an appropriate programming language and solved using an appropriate method. The underlying boundary constraints are defined in a file for the static model. The underlying boundary constraints are: (i) no host can take over sub-applications that exceed its resources, (ii) all sub-applications must be deployed on exactly one host that is on a platform on which the sub-application is allowed to be deployed and (iii) the host must make available the required software in the correct version.

The dynamic model contains boundary constraints that may vary from plan to plan, for example, that particular sub-applications are not allowed to be deployed jointly, i.e., are not allowed to run on the same host.

The deployment planner (Deployment Planner) creates a file from its input. If the programming language can only operate with integers and matrices, then the data from the input must be adapted to the structure of this programming language. The illustration as to which resources are available on which host/which platform is illustrated, for example, as a matrix (h×r), where h represents the host/the platform and r represents the resource, and where the number n in the position (h, r) specifies how many resources r the host/the platform h has.

The result of the solution method is a single assignment matrix or data series, where the number i at position j expresses that the sub-application j is assigned to the host/the platform i, i.e., is deployed thereon. This assignment matrix or data series is accordingly translated back by the deployment planner (Deployment Planner) and the result is routed back to the deployment service (Deployment Service).

The deployment planner (Deployment Planner) takes care of actually deploying the sub-applications. If the target platform is a cloud platform, an appropriate program library is used for the deployment. If the target platform is an edge platform, then the deployment planner (Deployment Planner) transmits a command to the corresponding manager of the units (Device Manager), which then loads the software artifact and launches the sub-application. The device manager monitors the sub-application and transmits measured values to the quality unit (QoS Watcher, see FIG. 2), which monitors the quality of the execution of the sub-application and forwards the measured values to the complex event processing unit CEP. The MAPE cycle thus ends. Only if the developer decides to initiate a new deployment, or if the complex event processing unit CEP detects a corresponding event, is the entire chain for deploying the sub-applications then restarted.

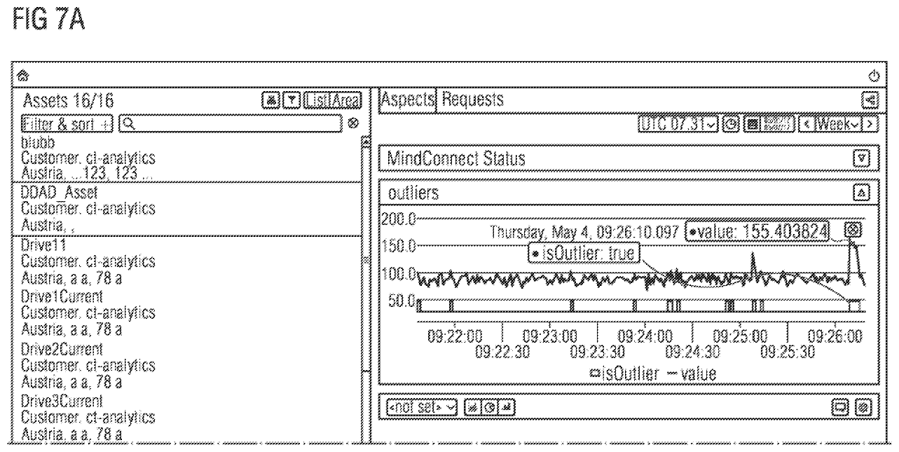

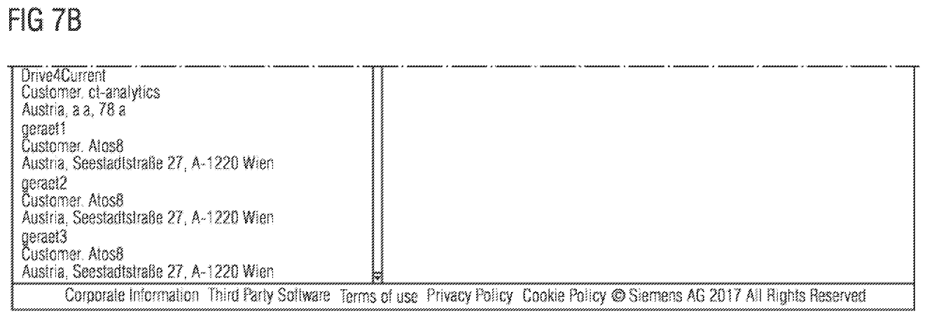

FIG. 7 shows the incorporation of the outlier application into the application “Fleet Manager”, which runs on the “MindSphere Platform”, see FIG. 2, and which monitors and controls a plurality of motors here. The available views in the “Fleet Manager” are illustrated on the left in FIG. 7, and the selected view, which is created using the outlier application, is illustrated on the right. The upper curve, on the right, shows the temporal profile (stored in “Time Series”) of measured values of the temperature of a motor. “1” in the lower curve indicates that an outlier is present, and “0” indicates that no outlier is present. The application “Fleet Manager” may then output an alarm signal if an outlier is identified.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-15. (canceled)

16. A computer-implemented method for deploying sub-applications of a particular application on computers of at least two different levels, each comprising at least one specific platform, a first level having a greater level of computational power available than a second level, the method comprising:
recording constraints for execution of the application and recording the individual sub-applications in a database;
recording requirements, corresponding to the constraints for execution, of the different levels, comprising requirements of the at least one platform of a level, in the database;
selecting the sub-applications required for the particular application;
creating and solving automatically a constraint satisfaction problem from the constraints for the application and also for the individual sub-applications and from the relevant requirements of the different levels comprising at least one platform of the levels; and
deploying the sub-applications on computers of the different platforms in accordance with the solution to the constraint satisfaction problem.

17. The computer-implemented method as claimed in claim 16, wherein costs of resources on the individual platforms are taken into consideration when creating the constraint satisfaction problem.

18. The computer-implemented method as claimed in claim 16, wherein at least one of (i) the constraints for the execution of the sub-applications, (ii) the requirements of the different levels and (iii) the specific platforms comprise at least one of the following properties: reliability, availability, scalability, confidentiality, efficiency, safety, usability, prices of different resources, communication with other sub-applications and platforms.

19. The computer-implemented method as claimed in claim 17, wherein at least one of (i) the constraints for the execution of the sub-applications, (ii) the requirements of the different levels and (iii) the specific platforms comprise at least one of the following properties: reliability, availability, scalability, confidentiality, efficiency, safety, usability, prices of different resources, communication with other sub-applications and platforms.

20. The computer-implemented method as claimed in claim 16, wherein at least one of (i) the constraints for the execution of the sub-applications, (ii) the requirements of the different levels, (iii) the specific platforms and (iv) the individual computers comprise at least one of the following properties: presence of at least one particular additionally required item of hardware and software comprising a correct software version.

21. The computer-implemented method as claimed in claim 16, wherein at least one sub-application is deployed on a particular computer of a specific platform of a level in accordance with the solution to the constraint satisfaction problem.

22. The computer-implemented method as claimed in claim 16, wherein the constraints for the execution of the sub-applications comprise particular boundary constraints being determined automatically, based on information which is present.

23. The computer-implemented method as claimed in claim 16, wherein the constraints for the execution of the sub-applications comprise that communication is possible between at least two mutually dependent sub-applications which are deployed on at least two different platforms.

24. The computer-implemented method as claimed in claim 16, wherein, in the event of a change in a requirement of the different platforms, the constraint satisfaction problem is changed and solved again, and the sub-applications are redeployed on computers of the different platforms in accordance with a new solution to the constraint satisfaction problem.

25. The computer-implemented method as claimed in claim 24, wherein the change in the requirement of the different platforms is a change in a state or to a rule of a platform or of a computer of a platform.

26. The computer-implemented method as claimed in claim 25, wherein the change in the requirement of the different platforms is a change in the loading of a platform or of a computer of a platform.

27. The m computer-implemented method as claimed in claim 16, wherein at least one constraint for the execution of the sub-applications is specified by a responsible individual.

28. The computer-implemented method as claimed in claim 16, wherein, in cases of events specified by the user, the constraint satisfaction problem is changed and solved again, and the sub-applications are redeployed on computers of the different platforms in accordance with a new solution to the constraint satisfaction problem.

29. The computer-implemented method as claimed in claim 16, wherein at least one platform of the first level is a computer cloud which is reachable via the Internet.

30. The computer-implemented method as claimed in claim 16, wherein at least one platform of the second level is a computer network located proximate to the user of the method and which allows a temporally shorter data transport from and to the computer of the user than a platform of the first level.

31. The computer implemented method as claimed in claim 16, wherein the database comprises a graph database.

32. A non-transitory computer readable medium encoded with program commands of a computer program which, executed by a computer, prompt said computer to deploy sub-applications of a particular application on computers of at least two different levels, each comprising at least one specific platform, a first level having a greater level of computational power available than a second level, the computer program comprising:
program commands for recording constraints for execution of the application and recording the individual sub-applications in a database;
program commands for recording requirements, corresponding to the constraints for execution, of the different levels, comprising requirements of the at least one platform of a level, in the database;
program commands for selecting the sub-applications required for the particular application;
program commands for creating and solving automatically a constraint satisfaction problem from the constraints for the application and also for the individual sub-applications and from the relevant requirements of the different levels comprising at least one platform of the levels; and
program commands for deploying the sub-applications on computers of the different platforms in accordance with the solution to the constraint satisfaction problem.
